(19) United States
(12) Patent Application Publication
(10) Pub. No.: US 2009/0048879 A1
(43) Pub. Date: Feb. 19, 2009

(54) Systems and methods for enabling hospitality employees to share benefits in an online environment

(76) Inventor: Wasantha Weerasekera, Kent, WA (US)

Correspondence Address: Wasantha Weerasekera, 27922 146th Ave. SE, Kent, WA, 98042, US

(21) Appl. No.: 12/080,389

(22) Filed: Apr. 2, 2008

Related U.S. Application Data
(60) Provisional application No. 60/964,579, filed on Aug. 13, 2007.

(51) Int. Cl. G06Q 30/00; G06Q 10/00

(52) U.S. Cl. 705/6; 705/27

(57) ABSTRACT

The present invention relates to systems and methods for online procurement of hospitality-related benefits. More particularly, the present invention relates to systems, methods, and applications for enabling hospitality employees to request, purchase, reserve, share, and receive benefits in an online environment. According to certain embodiments of the present invention, such methods generally comprise (a) providing a website accessible by a plurality of hospitality vendors and a plurality of hospitality employees; (b) providing a listing portal within the website in which hospitality vendors may register an offer, wherein the offer represents an opportunity to reserve and purchase a hospitality package; and (c) providing a means for enabling a hospitality employee to accept the offer, wherein individuals who are not hospitality employees are unable to accept the offer.

### CROSS-REFERENCE TO RELATED APPLICATIONS

This application claims priority to, and incorporates by reference, U.S. provisional patent application Ser. No. 60/964,579, filed Aug. 13, 2007.

### FIELD OF THE INVENTION

The field of the present invention relates to the field e-commerce and, more particularly, systems and methods for online procurement of hospitality-related benefits. More specifically, the present invention relates to systems, methods, and applications for enabling hospitality employees to request, purchase, reserve, share, and receive benefits in an online environment.

### BACKGROUND OF THE INVENTION

For years, hospitality employees and contractors have enjoyed certain preferred benefits offered by their employers. More particularly, it is often the case that an employee of a particular hospitality vendor, such a hotel, is provided the ability to purchase the services of their employer at discounted rates. For example, a hotel employee may be allowed to purchase a night stay in his or her employer's hotel for a discounted price. In most cases, however, such discounted rates (or other benefits) may only be redeemed within a particular hospitality destination (e.g., hotel or chain of hotels). In addition, the means by which such hospitality employees request, reserve, and purchase services from their employers, such as by reserving a room in an employer-hotel, are not standardized (and often vary from vendor-to-vendor).

In view of the foregoing, there is a need for a centralized source where hospitality employees may request, reserve, and purchase the services offered by their hospitality-related employer. Moreover, there is a need for a centralized source where hospitality employees may request, reserve, and purchase the services offered by a plurality of different hospitality vendors. Preferably, the centralized source will enable such employees to purchase the services at discounted rates, or otherwise receive other benefits to which the public at large does not have access. As described further below, the present invention addresses many of the foregoing needs.

### SUMMARY OF THE INVENTION

According certain preferred embodiments of the present invention, methods for enabling hospitality employees to share benefits in an online environment are provided. Such methods generally comprise providing a website accessible by a plurality of hospitality vendors and a plurality of hospitality employees. The website includes a listing portal in which hospitality vendors may register an offer or, more specifically, an opportunity to reserve and purchase a hospitality package, e.g., a hotel or resort reservation, an airline ticket, a cruise, and the like. The website preferably comprises a means for enabling only hospitality employees to reserve and/or purchase such hospitality packages within the website. In certain related embodiments, the website is designed such that only hospitality employees may access the majority of the website, such as by employing a home page requiring that certain login information be entered (and submitted to a server), before such employees may enter the website (or a portion thereof which allows individuals to purchase hospitality packages).

According to further preferred embodiments of the present invention, systems for enabling hospitality employees to share benefits in an online environment are provided. The systems generally comprise (i) a data processing system in which a website may be accessed by a plurality of hospitality vendors and/or a plurality of hospitality employees; and (ii) a server in which the website is hosted. According to such embodiments, the website comprises a listing portal in which hospitality vendors may register an opportunity to reserve and purchase a hospitality package and a means for enabling only hospitality employees to reserve and purchase such hospitality packages.

The above-mentioned and additional features of the present invention are further illustrated in the Detailed Description contained herein.

### BRIEF DESCRIPTION OF THE DRAWINGS

FIG. 1 is a flow chart that outlines certain methods for enabling hospitality employees to share benefits in an online environment.

FIG. 2 is a flow chart that outlines certain methods for enabling only hospitality employees to purchase a hospitality package in an online environment.

FIG. 3 is a non-limiting example of an on-line form which may be used to search for hotel rooms (a hospitality package) that are being offered for a discount to hospitality employees as described herein.

FIG. 4 is a flow chart that outlines additional methods for enabling only hospitality employees to purchase a hospitality package in an online environment, by granting access to a website (or a portion thereof only to registered hospitality employees.

FIG. 5 is a non-limiting example of an on-line form which may be used by a hospitality employee to “login” to the centralized website, and query a database for desired hospitality packages.

FIG. 6 is a non-limiting example of an on-line form which may be used by a hospitality vendor to “login” to the centralized website, and add, delete, or modify one or more offers for certain hospitality packages.

FIG. 7 is a non-limiting example of an on-line form which may be used by a hospitality vendor to register with the centralized website.

FIG. 8 is a diagram showing how the website described herein may be accessed and used by a plurality of hospitality employees and vendors.

FIG. 9 is a diagram showing how the website described herein may be integrated with the intranets of various hospitality vendors.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

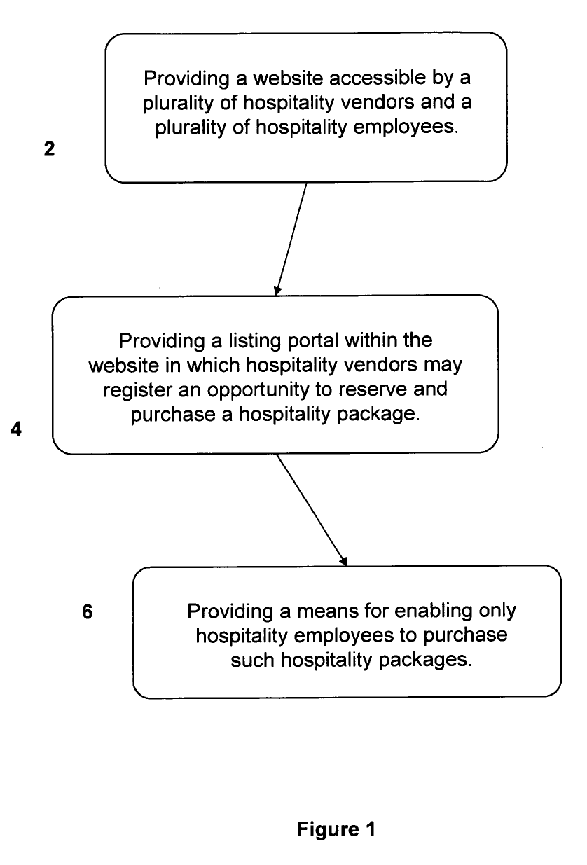

According to certain preferred embodiments of the present invention, methods for enabling hospitality employees to share benefits in an online environment are provided. Referring to FIG. 1, such methods generally comprise providing a website accessible by a plurality of hospitality vendors and a plurality of hospitality employees 2. The website includes a listing portal in which hospitality vendors may publish an offer or, more specifically, an opportunity to reserve and purchase a hospitality package 4, e.g., a hotel or resort reservation, an airline ticket, a cruise, a restaurant package, a car rental, a casino package, a tour, and the like.

The website preferably further comprises a means for enabling hospitality employees to reserve and/or purchase such hospitality packages within the website 6. For example, the website may be equipped with credit card, debit card, PayPal®, and/or bank transfer processing capabilities, such that a hospitality employee may quickly and easily purchase a hospitality package from a hospitality vendor. In certain embodiments, the payment is received by a third party, such as the owner or operator of the website, and then transferred to the hospitality vendor. The invention provides that in such embodiments, the website owner or operator may retain a percentage of the payment received from the hospitality employee, as a commission, and transfer the remaining balance to the applicable hospitality vendor. In other embodiments, the hospitality employee's payment is provided directly to the hospitality vendor.

The invention provides that the offers to purchase such hospitality packages are only extended to hospitality employees (or to such other individuals (or businesses) that one or more hospitality vendors specify). A variety of means may be employed by which a website (and corresponding server) may distinguish hospitality employees from non-hospitality employees. As used herein, the term “hospitality employee(s)” refers to those individuals who are actually employed by a hospitality vendor, such as a conventional employee or an independent contractor who performs work for a hospitality vendor. In certain embodiments, the invention provides that hospitality vendors may have control over who shall be considered a hospitality employee (and who shall not). Specifically, for example, the invention provides that each hospitality employee may be provided with a membership identifier, which may be used to access the website described herein and purchase hospitality packages. In such embodiments, a hospitality vendor may unilaterally control who is provided with such membership identifiers (and who is not).

In other embodiments, the server from which the website is hosted may employ its own means for determining whether an individual is a hospitality employee. In these embodiments, the hospitality vendor may not control who is (and who is not) considered a hospitality employee. For example, the server from which the website is hosted may have access to a database which houses the employee identification numbers (EINs) of all businesses in the hospitality industry. As such, if an individual provides the server (through the website) with an EIN that is listed in the database for a hospitality vendor, the server may validate and consider the individual to be a hospitality employee. Alternatively, the website may require that an individual simply acknowledge and agree to an on-line agreement, which requires the individual to represent and warrant that he/she is a hospitality employee.

In certain embodiments of the present invention, hospitality vendors may pay a membership fee. The membership fee may be in consideration for (a) the entitlement of its employees to have access to the website described herein and to purchase services from other hospitality vendors at discounted rates (for example), (b) the right of a hospitality vendor to post offers to purchase hospitality packages within the website (insofar as sales of such hospitality packages may still generate certain income for such vendors, even at discounted rates), or (c) a combination of the foregoing.

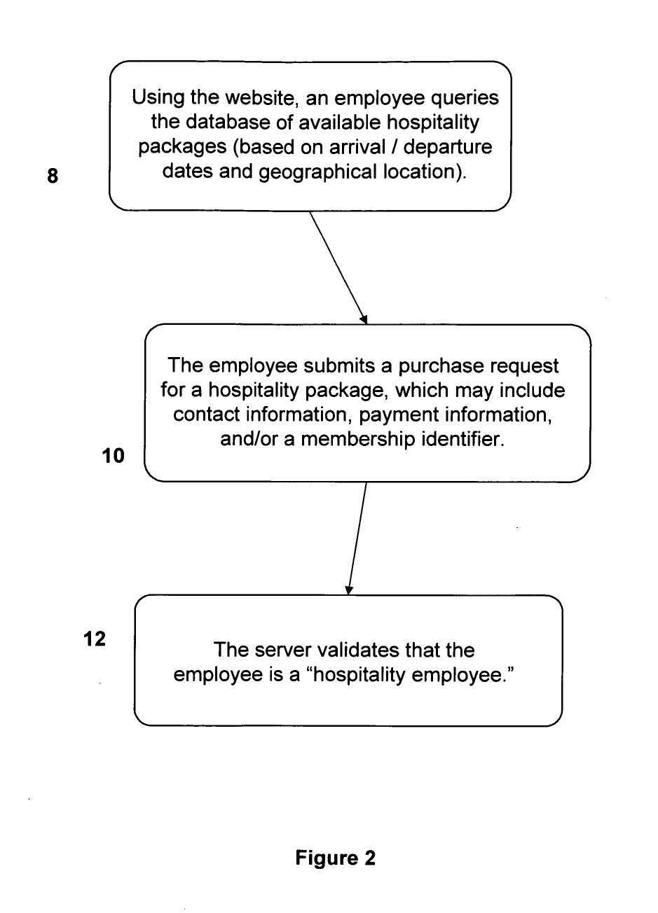

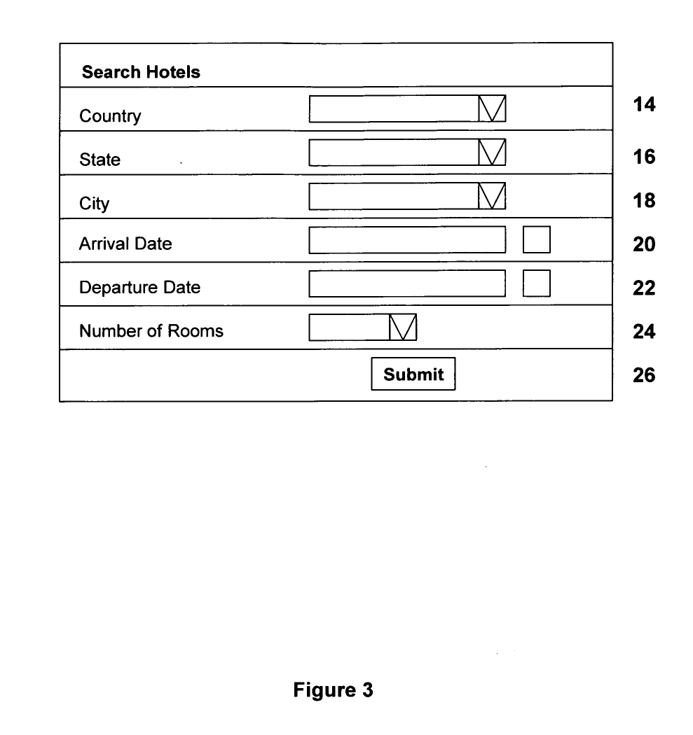

Referring to FIG. 2, and as described above, the invention provides that the website described herein may be accessed and used only by hospitality employees (and hospitality vendors). The website will preferably allow hospitality employees to search for a desired hospitality package 8 using any of various criteria, such as geographical location, arrival date, departure date, the number of desired rooms in a hotel or resort, and/or other criteria. More specifically, for example, and referring to FIG. 3, when the hospitality employee is searching for a discounted hotel room, the employee may enter certain criteria into an on-line form, such as the destination country 14, state 16, and city 18. These criteria may be selected from a set of pre-defined options, such that the on-line form may employ a “drop-down” box therein to facilitate a desired and valid selection for these criteria. In addition, the employee may identify the desired arrival date 20, departure date 22, and the desired number of rooms 24. The on-line form may be capable of launching a viewable calendar, which allows the employee to visually and easily select the desired arrival 20 and departure 22 dates. These search criteria specified by a hospitality employee may be submitted to a server by selecting a submit button 26 within the on-line form, which causes the selected criteria to be submitted to the server. The server will then compare the employee's search criteria to the content of a hospitality directory and text fields therein (described below), such that relevant search results are subsequently displayed to the hospitality employee.

Upon identifying a desired hospitality package, and referring again to FIG. 2, the employee may submit certain contact and/or payment information, including for example a membership identifier 10, which may be used to reserve such employee's right to purchase the hospitality package (and/or actually submit payment using a credit card, debit card, or back account transfer). Upon submission of such data, a server verifies that such employee is an authorized hospitality employee 12, e.g., by verifying the authenticity of the membership identifier submitted by such employee (or other suitable means), before finalizing the transaction.

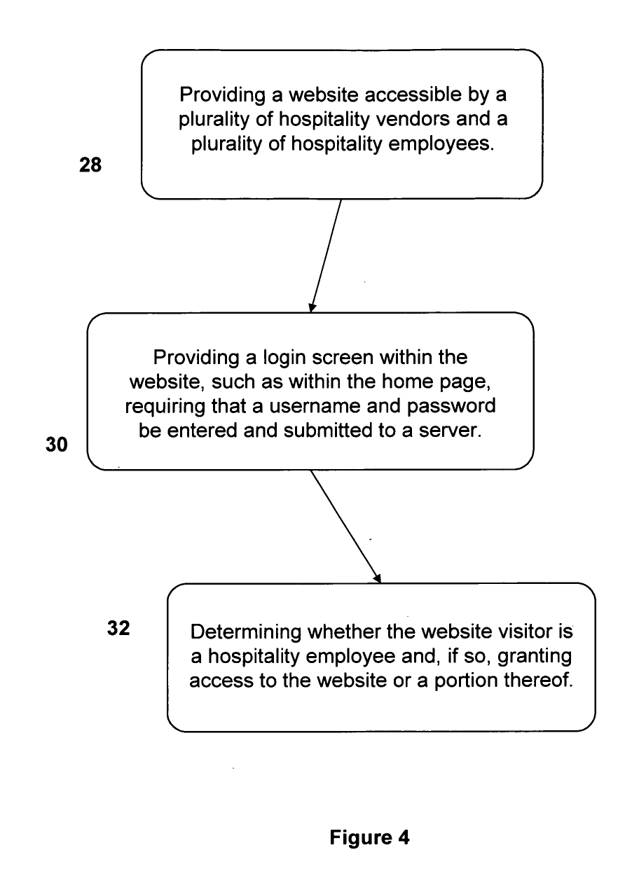

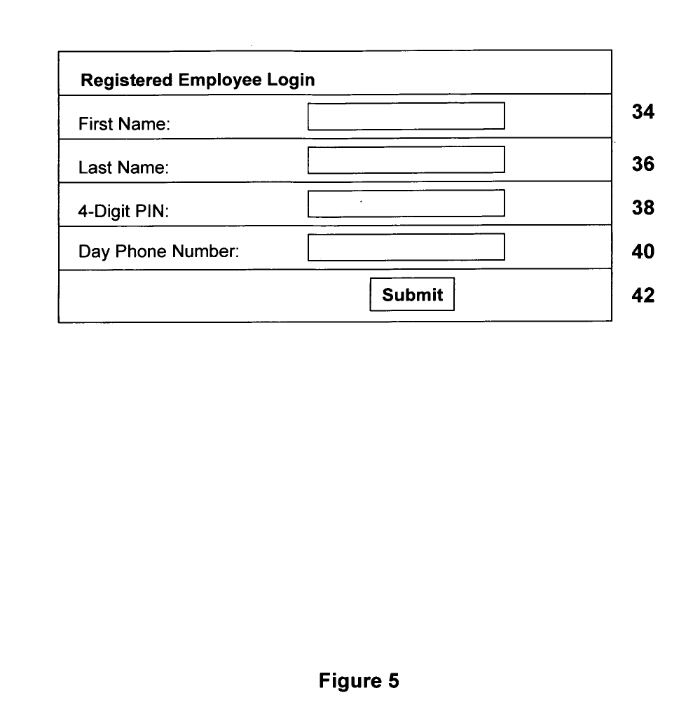

As described herein, the website is preferably designed such that only hospitality employees may access the majority of the website. For example, referring to FIG. 4, a website may be provided, which a plurality of hospitality employees and employers (vendors) may access 28. The website may employ a home page, or login page 30, which requires that certain login information be entered (and submitted to a server). FIG. 5 provides a non-limiting example of an on-line form, which may be used to submit such login information to a server, such as the employee's first name 34, last name 36, a 4-digit personal identification number (PIN) 38 (which is either assigned by the server or specified by the employee and recorded in a database), and daytime phone number 40, all of which may be provided to a server by selecting a submit button 42. In addition to these login criteria, a server could also request the employee's email address, username, password, a combination thereof, or other unique criteria. The server receives such login information and determines whether the website visitor is a hospitality employee 32, as described above. More specifically, the server may compare the login criteria to a database, which houses the criteria for all hospitality employees who should be granted access to the website and the right to purchase discounted hospitality packages offered therein (either as a result such hospitality employees registering with the website themselves or vis-à-vis a hospitality vendor registering its own employees). If it is determined that such visitor is a hospitality employee, the visitor is granted access to the website (or a portion thereof which allows such visitor to purchase hospitality packages) 32.

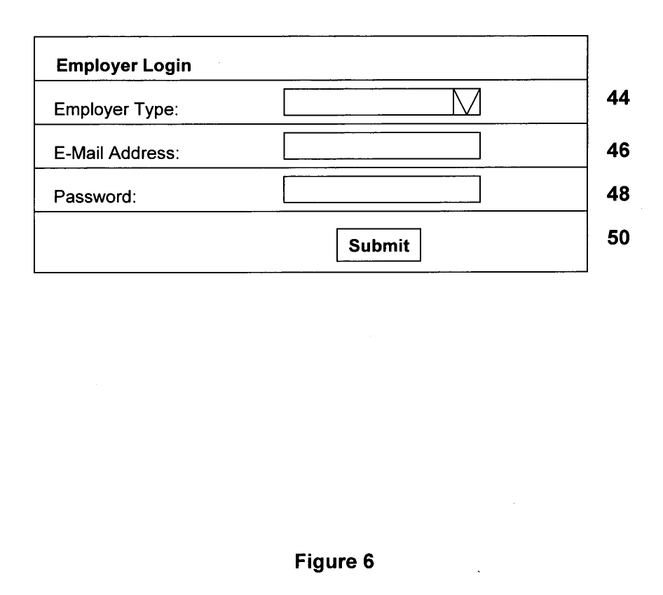

The invention may employ certain means, such as on-line forms accessible within the website described herein, which may be used by hospitality vendors wishing to apply for membership to and receive the services of the website described herein. For example, FIG. 6 provides an exemplary web page in which a hospitality vendor may login to an account page, by selecting the appropriate employer type 44 (preferably from a pre-defined list, such as a hotel, resort, airline, cruise line, restaurant, car rental company, casino, or tour company) and entering its account email address 46 and password 48. Upon submission of this information, a server in which the website is hosted may use such information to verify the identity of such hospitality vendor and, optionally, display an account page that is tailored to the applicable hospitality vendor. As used herein, the term “hospitality vendor” refers to any person or business that offers a service or product within the hospitality industry, which includes (but is not limited to) hotels, resorts, airlines, tour companies, theme parks, casinos, theatres, cinemas, cruise lines, rental car companies, restaurants, travel agents, and the like.

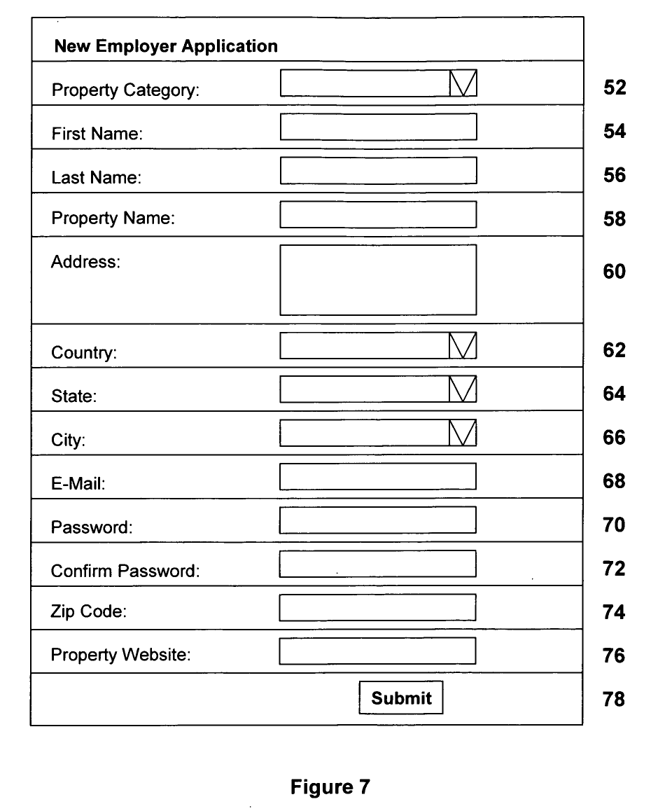

If the hospitality vendor has not yet registered with the website, the website may employ another on-line form, which allows a hospitality vendor to register with the website and become a member thereof. FIG. 7 provides a non-limiting example of an on-line form that may be used to submit such membership application-type information to a server, which will then be recorded and housed in a database. For example, the on-line form may require that the hospitality vendor identify its hospitality industry (or property category) 52, preferably from a pre-defined list of such industries or property categories. In addition, the on-line form may require the hospitality vendor to provide a first and last name of a contact person 54,56; the name of its property or business 58; its address 60-66,74; and its email address 68, desired password 70,72, and website address (URL) 76, which may then be submitted to the server 78. Upon submission of the foregoing information to a server, the hospitality vendor may be considered registered with the website and allowed to benefit from its services (e.g., publish offers to purchase hospitality packages therein and enable its employees to purchase such packages offered by other vendors within the website). Such information may further be used to (i) establish an account page for such vendor in which the vendor may publish offers to purchase hospitality packages and (ii) invoice such vendors for having access to the website and receiving the services provided therein (such as in the form of the membership fee and/or commissions described above).

In such embodiments, upon accessing the hospitality vendor's account page (or other restricted area within the website), the hospitality vendor is allowed to publish one or more offers to purchase a hospitality package. An offer to purchase a hospitality package that is submitted may include certain text fields, which may contain information regarding each hospitality package, such as price, geographical location (which may be numerically identified with a zip code or other geographical identifier), hospitality package-type (i.e., an indication as to whether the package includes a hotel room, an airline ticket, a concert ticket, etc.), dates of availability, information concerning eligibility requirements, if any, for hospitality employees, and other terms specified by the particular hospitality vendor. The invention further provides that a hospitality vendor may, optionally, publish pictures, audio content, and/or video content regarding each hospitality package, such as, for example, a video clip (or picture slide show) exhibiting different views of a hotel.

Preferably, the text fields that are populated by a hospitality vendor regarding a hospitality package will be housed within segregated domains within a database, such that the contents thereof may be queried by interested hospitality employees. A non-limiting example of a web page in which a hospitality employee may query such a database is shown in FIG. 3. In addition, in certain embodiments, the invention provides that the website may comprise a directory of different hospitality packages. For example, as used herein, “hospitality packages” refers to any service (or entertainment package) that is generally considered to be within the hospitality industry, including without limitation a hotel reservation, a vacation resort package, an airline ticket, a tour, a theme park ticket, a reservation within a casino, a theatrical or cinema ticket, a cruise ticket, a rental car reservation, and/or a restaurant reservation. Accordingly, the above-mentioned directory may include a variety of categories that may be independently searched and viewed by hospitality employees, whereby each category may include listings of offers for hospitality packages which are tailored to one or more of the above-listed package-types (e.g., hotels, resorts, airline tickets, etc.).

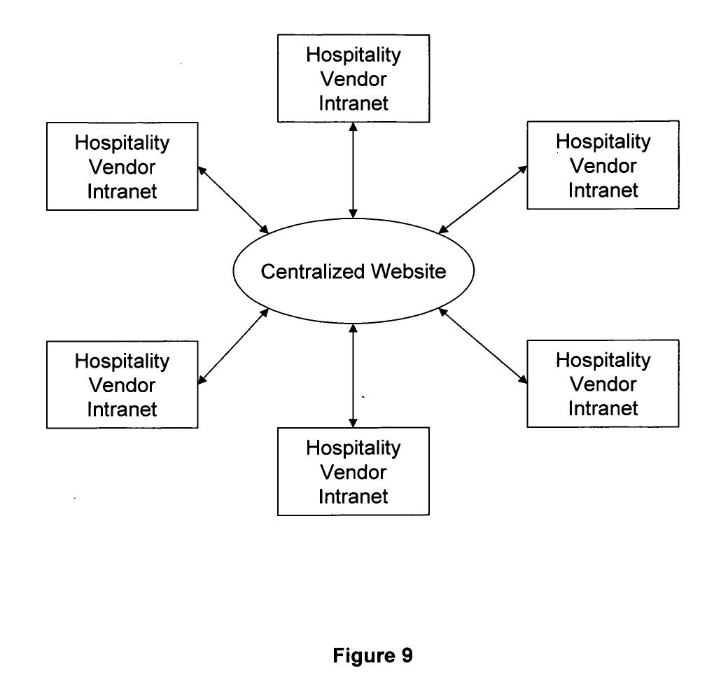

The invention provides that a hospitality vendor may establish a link between the vendor's intranet (which may only be accessed by authorized employees of the vendor) and the centralized website described herein. For example, referring to FIG. 9, the invention provides that the website described herein may serve as a centralized source for hospitality employees to purchase hospitality-related services (at, for example, discounted prices), whereby the website may be conveniently accessed within their employer's intranet (through a hyperlink, for example). This way, the centralized website described herein is seamlessly integrated with the business and intranet of a variety of hospitality vendors.

According to additional embodiments of the invention, the centralized website described herein may be integrated with third party travel websites. For example, various third party travel websites exist, which enable a consumer to search for airplane tickets, hotels reservations, and other hospitality arrangements. These third party websites often allow a consumer to search, for example, for available flights, hotel rooms, etc., based on dates of arrival and departure, airline or hotel vendor preference, price, and other criteria. Following a search with such third party websites, the invention provides that the search results may return at least two prices associated with each search listing, namely, a price for the public and a price for hospitality employees who are registered with the centralized website described herein. Alternatively, upon selecting a desired flight or hotel package, the consumer may be invited to submit, if applicable, a membership identifier that indicates the consumer is a hospitality employee who is entitled to a discounted price.

According to further embodiments, the invention provides that the operator, manager, and/or owner of the centralized website described herein, which serves as a centralized source of hospitality packages for hospitality employees, may pre-negotiate the rates and other terms that apply to such hospitality packages with hospitality vendors. That is, the invention contemplates that the website operator, manager, and/or owner will negotiate for and receive the commitment of a hospitality vendor to offer a hospitality package within the website at a discounted rate. Such approach will serve to ensure that at least a majority (if not all) of the hospitality packages offered within the website are discounted, thereby encouraging hospitality employees to visit the website and purchase hospitality packages offered therein.

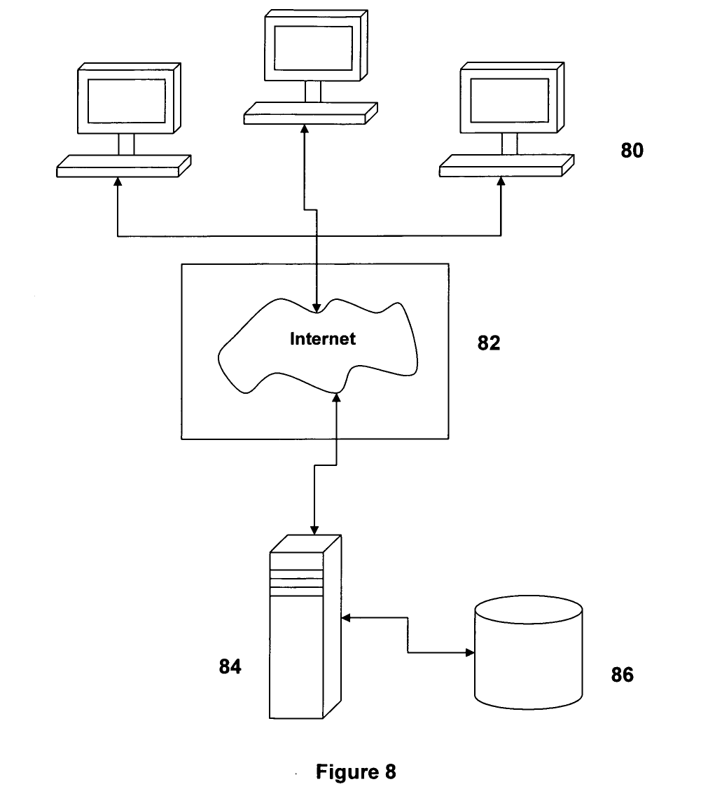

According to further preferred embodiments of the present invention, systems for enabling hospitality employees to share benefits in an online environment are provided. Referring to FIG. 8, for example, the systems generally comprise (i) one or more data processing systems, such as personal computers 80, which may be used by a plurality of hospitality vendors and a plurality of hospitality employees (as described above) to access the centralized website 82 described herein; and (ii) a server 84 in which the website 82 is hosted. According to such embodiments, as described herein, the website comprises a listing portal in which hospitality vendors may register an opportunity to reserve and purchase a hospitality package and a means for enabling only hospitality employees to reserve and purchase such hospitality packages. These systems will further include one or more databases 86, which will record and house the information related to each hospitality employee and vendor entitled to use the website, information related to each hospitality packaged that is offered at any given time, and other information which the server 84 may need to access.

The invention provides that the data processing system may comprise any device that is capable of accessing the website described herein vis-à-vis an internet connection. Non-limiting examples of such devices include, but are not limited to, a personal computer, a kiosk, a cellular telephone, a smart phone, a PDA, or any similar device (currently existing or developed hereafter).

It is to be understood that both the general description and the detailed description are exemplary and explanatory, but are not restrictive of the invention. The invention in its broader aspects is not limited to the specific details shown and described, and departures may be made from such details without departing from the principles of the invention and without sacrificing its chief advantages.

What is claimed is:

1. A method for enabling hospitality employees to share benefits in an online environment, which comprises:
(a) providing a website accessible by a plurality of hospitality vendors and a plurality of hospitality employees;
(b) providing a listing portal within the website in which hospitality vendors may register an offer, wherein the offer represents an opportunity to reserve and purchase a hospitality package; and
(c) providing a means for enabling only a hospitality employee to accept the offer, wherein individuals who are not hospitality employees are unable to accept the offer.

2. The method of claim 1, wherein the hospitality package is selected from the group consisting of: a hotel reservation, a vacation resort package, an airline ticket, a tour, a theme park ticket, a reservation within a casino, a theatrical or cinema ticket, a cruise ticket, a rental car reservation, a restaurant reservation, and any combination thereof.

3. The method of claim 2, wherein the hospitality vendor is a company, individual or organization authorized to extend the offer to purchase the hospitality package.

4. The method of claim 3, wherein the hospitality employee in an employee or authorized contractor of a hospitality vendor.

5. The method of claim 4, wherein the means for enabling a hospitality employee to accept the offer comprises an online form in which the employee enters his or her contact information.

6. The method of claim 5, wherein the employee further enters a membership identifier into the form, wherein the membership identifier authenticates that said employee is a hospitality employee.

7. The method of claim 5, wherein the employee further enters payment information to accept the offer and purchase the hospitality package, wherein the website further comprises a payment system capable of processing said payment information.

8. The method of claim 1, wherein upon the hospitality employee accepting the offer, a server validates that the employee is an employee of a hospitality vendor.

9. The method of claim 8, wherein the server validates that the employee is an employee of a hospitality vendor by verifying that a membership identifier provided by the employee is listed in a database to be correlated with a person who has been granted access to the website and a right to purchase discounted hospitality packages therein.

10. The method of claim 1, wherein the listing portal within the website allows hospitality vendors to specify terms of the offer.

11. The method of claim 10, wherein the terms of the offer comprise a price of the hospitality package.

12. The method of claim 1, wherein the website comprises an online form that hospitality employees may use to query a database housed within a server, whereby the database comprises searchable information related to hospitality packages.

13. The method of claim 12, wherein the hospitality packages are hotel and resort reservations.

14. The method of claim 13, wherein the information comprises city destination, state destination, arrival date, departure date, and the number of rooms requested.

15. The method of claim 1, wherein employers of the hospitality employees pay a membership fee, which allows the employees thereof to accept the offers and purchase the corresponding hospitality packages.

16. A system for enabling hospitality employees to share benefits in an online environment, which comprises:
(a) a plurality of data processing systems in which a website may be accessed by a plurality of hospitality vendors and a plurality of hospitality employees; and
(b) a server in which the website is hosted, wherein:
(i) the website comprises a listing portal in which hospitality vendors may register an offer,
(ii) the offer represents an opportunity to reserve and purchase a hospitality package, and
(iii) the website comprises a means for enabling a hospitality employee to accept the offer, wherein individuals who are not hospitality employees are unable to accept the offer.

17. The system of claim 16, wherein the plurality of data processing systems are selected from the group consisting of a personal computer, a kiosk, a cellular telephone, a smart phone, a PDA, and a combination thereof.

18. The system of claim 17, wherein the server validates that the employee is an employee of a hospitality vendor by verifying that a membership identifier provided by the employee is valid and authentic.

19. The system of claim 18, wherein the website comprises an online form that hospitality employees may use to query a database housed within the server, whereby the database comprises searchable information related to hospitality packages.

20. The system of claim 19, wherein (a) the hospitality packages are hotel and resort reservations and (b) the information comprises city destination, state destination, arrival date, departure date, and the number of rooms requested.
